(19) United States
(12) Patent Application Publication
(10) Pub. No.: US 2011/0219113 A1
(43) Pub. Date: Sep. 8, 2011

(54) METHOD AND SYSTEM FOR CLIENT ASSISTED STATEFUL HANDLING OF PACKETS IN A COMMUNICATIONS NETWORK

(76) Inventors: Avininder Pal Singh GREWAL, Surrey (CA); Zeljko OLUIC, Vancouver (CA)

(21) Appl. No.: 13/039,239

(22) Filed: Mar. 2, 2011

Related U.S. Application Data
(60) Provisional application No. 61/309,743, filed on Mar. 2, 2010.

(51) Int. Cl. G06F 15/16

(52) U.S. Cl. 709/224

(57) ABSTRACT

A method and system for stateful handling of packets in a network are described. In a client-server network environment, the stateful inspection of incoming protocols is offloaded from the server and distributed to the client device. The stateful inspection, as well as the provisioning of the client with the necessary functions required by the handlers, is referred to as Client Assisted Application Level Gateway (ALG). This version of ALG, in which the client performs or assists the server by performing at least some of the inspection and provisioning tasks, allows for a marked performance gain to the network gateway by reducing its packet inspection load.

### CLAIM OF PRIORITY

This application claims the benefit of U.S. Provisional Patent Application 61/309,743 entitled Client Assisted Stateful Handling, by Avininder P. Grewal et al., filed Mar. 2, 2010 (Attorney Docket No. 1198.03), the entire contents of which are incorporated herein by reference.

### FIELD OF THE INVENTION

One or more implementations relate generally to packet-based networks, and more specifically to handling network packets through gateways and firewalls.

### BACKGROUND

In TCP (transmission control protocol) based networks, stateful firewalls keep track of the state of network connections traveling across them and distinguish legitimate packets for different types of connections. Current solutions to improving the stateful packet transfer inward through Network Address Translators (NATs) have not been found to be sufficient enough to satisfy the needs of a growing community of networks, as they are either too processor demanding or they require the use of an external server.

NAT devices are generally inserted into a network topology in order to prevent using up all available IPv4 address space. They allow for private IP addresses on either personal or business networks that fall behind a router with a public IP address to be visible to the Internet. Devices that lie behind the NAT are permitted to communicate with external hosts by altering the source IP address of all outgoing packets to that of the NATs public IP address. The NAT, in return, relays replies back to the device where the session initiation began. This creates a problem for all external devices that try to initiate a connection to an internal device, because the NAT has no way to discern to which destination device the incoming packets are intended.

A common application that requires a stateful handling of packets at a NAT is Active File Transfer Protocol (FTP), which is an application for which a NAT is ill-suited. In general, active FTP is the method of FTP in which the client starts listening on a TCP socket and communicates both its IP Address and TCP Port to the server through the control channel. The client then makes a second connection, intended for data, by sending a PORT command to the host server, which then communicates this information. When this command is received by the server, the server attempts a TCP connection back to the client specified IP and the port. As the port command contains the client's local IP address and TCP port, the behaviour of FTP server is not deterministic in that the server can only see the NAT IP address, which does not match the client IP Address.

A common method to solve the problem of stateful handling of packets is through the use of an Application Level Gateway (ALG). In computer networking, an ALG augments the firewall or NAT functionality by conducting an inspection of the forward data flows in order to correctly map them to their appropriate applications. Such stateful handlers are conventionally implemented as modules running on top of the gateway to the network (e.g. NAT).

A further application that assumes the stateful handling of data packets is a Real-Time Streaming Protocol (RTSP) application supporting Real-Time Protocol (RTP) and the Real Data Transport (RTD) streaming over User Datagram Protocol (UDP). This type of application requires the NAT gateway to correctly map and forward the incoming UDP stream to the appropriate client. As the RTSP client communicates the streaming ports for receipt of the stream over the RTSP control channel, and the Port Address Translator (PAT) translates the IP address from private to public, the problem of PAT behaviour that will occur here is analogous to the above described problem with NATs and Active FTP.

One possible approach for Peer-To-Peer (P2P) communication involves the use of two specially designed routers that are each imbedded with a translation mechanism. Each router translates outgoing datagrams from private source addresses to public source addresses in such a way that these newly translated public addresses can be reverse-translated back into their initial private source addresses by the second router that receives the datagram. This second router, equipped with similar translation mechanism, forwards the newly translated datagrams to the destination. Both routers are aware of all peripheral private IP addresses behind all routers and therefore accept incoming data for destinations behind all such routers. The disadvantage of this approach is that it requires all routers on the Internet to be equipped with such a translation mechanism. In this case, each router will be burdened with an extensive translator that will require global updates whenever a new device enters the network either publicly or privately. In addition, this method puts more strain on the NAT, especially when the NAT is a public gateway for a great number of devices.

A more common solution to the problem of stateful handling through a NAT-like device is Traversal Using Relay NAT (TURN). This method is a reliable, but not very efficient means of communicating across a NAT. The TURN method works by both parties connecting to a server with a public IP address, and then ‘relaying’ the data stream through the server. This method does allow for stateful handling and provides a means to access devices with private IP addresses, however, it has several drawbacks. These drawbacks include the fact that it consumes the server's processing power, increases the latency between clients, and assumes that both parties can establish and maintain connection with the server.

Another proposed solution is to introduce a proxy device to the network that intercepts both the control and data connections of an active FTP connection attempt. This proxy establishes a control connection with the server in response to a control connection request from the client, and then establishes a data connection with the server at the port selected by the server in response to a control connection request from the client. Following this, the proxy creates a data connection with the client at a fixed port of the client device. In this way, the proxy transparently intercepts both the control and the data connections and permits transit from the server selected port to the fixed proxy port and on to the client. As a safety precaution, the proxy device generates an acceptance criterion, which is based on the reception of a control request from the client. This solution may successfully evade the normal restrictive behaviour of NAT/network gateways. However, it relies on the proxy to perform the brunt of the work. In situations when there are numerous connection attempts through the proxy it can become overloaded. If this proxy were embedded within a network device (e.g. NAT), it may then again encounter the problem of overloading. An efficient solution would be one where the work performed by the gateway is negligible.

Yet another solution to the problem of the stateful handling of packets across network gateways is referred to as ‘UDP Hole Punching,’ and is described in the publication Peer-to-Peer Communication Across Network Address Translators, by Bryan Ford, Pyda Srisuresh, and Dan Kegel. This solution essentially consists of punching of a hole through the gateway to allow for nondiscriminatory access of incoming data. As such, this method requires that all packets be User Datagram Protocol (UDP) packets. It also presupposes the existence of a relaying server similar to TURN; however, the use of such a server is only in the initial stage, and is not absolutely required throughout the course of data transfer. FIG. 1 is a diagram that illustrates the components and methodology for UDP Hole Punching for stateful handling of TCP packets, as presently known in the art. As shown in FIG. 1, if two clients 111 and 112 want to establish a connection with each other then they must use a UDP connection. Client A 111 sends a TCP segment to the relaying server 113 over link 1. The relaying server 113 notifies client B 112 that client A 111 has the public IP address a.a.a.a and that it expects a UDP connection on a specific port (e.g., port 1234) over link 2. Client B 112 then sends its preferred UDP port, e.g. 4321, to the relaying server 113 and, simultaneously, sends a UDP datagram from source port 4321 to destination port 1234 to client A 111, link 3. Client B's local firewall 115 forwards the UDP datagram, creates a connection entry and the rule which allows incoming data from the destination address to traverse the firewall. Client A's local firewall 114 rejects the packet as per the typical behaviour of firewalls and NATs, however this is inconsequential. The relaying server 113 notifies client A 111 by way of the pre-existing TCP connection between them that Client B is accessible on IP address b.b.b.b and UDP port 4321, link 4. Client A 111 now sends a UDP datagram from source port 1234 to 4321, link 5. Client A's local firewall 114 then creates the appropriate dynamic entries. Since the dynamic entry in client B's local firewall 115 is still active, the UDP datagram from Client A to Client B passes through the firewall. As such, the communication channel is established even though the rules of each firewall/NAT dictate that under normal circumstances they would deny inbound connections admittance.

The UDP hole punching method is generally acknowledged to the most efficient method at present to statefully handle packets through network gateways and firewalls. However, this method still requires the use of an external server. Furthermore, depending on how many connections are currently being implemented, it can be demanding on external resources.

What is desired, therefore, is a more efficient approach to stateful handling of packets, and namely one would that circumvents the necessity for an external relaying server.

### BRIEF SUMMARY

In an embodiment and by way of example, there are provided mechanisms and methods for providing client assisted stateful handling in a packet-based network environment without requiring an external relaying server or unduly burdening external network resources.

Embodiments of a system for stateful handling of packets are implemented in a multimedia network environment in which wireless operators provide at least some of the communication services used by customers in a distributed network that includes both wired and wireless communication devices coupled over a central network, such as the Internet.

A network under an embodiment includes an ASM (aggregated session management) server that functions similar to an NAT, but has an additional footprint on user equipment (UE). The ASM server is configured to mete out the stateful handling of protocols to the software client imbedded on the user equipment, thus avoiding the indeterminism of typical NAT behaviour. This invention provides Internet Service Providers (ISPs) with a way of lowering their capital expenditure by extending the life of their existing equipment. Such equipment is very expensive to purchase and deploy, and embodiments described herein can extend the life of said equipment by increasing their effective capacity through further utilization. This invention is additionally beneficial for both wired and wireless networks as devices residing on both will inevitably require stateful handling of protocols at their respective network gateways. As such, the described embodiments allow for a decrease in operational expenditure in that it decreases the demand on current network gateways. Whereas other solutions to this problem are more demanding on the gateway, in the system and method presented herein, a hedging of processes is applied. As embodiments allow for stateful handling, there are obvious benefits for the customers of said ISPs. Particularly, each individual device would be permitted to employ applications that require stateful handling of protocols at the gateway, thus broadening the repertoire of accepted applications.

Embodiments of a system and method according for client assisted stateful packet handling include a software client embedded onto the user equipment with the user equipment residing on the private network side of the NAT. This software client relieves the NAT of much of the burden of stateful handling.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a diagram that illustrates the components and methodology for UDP Hole Punching for stateful handling of TCP packets, as presently known in the art.

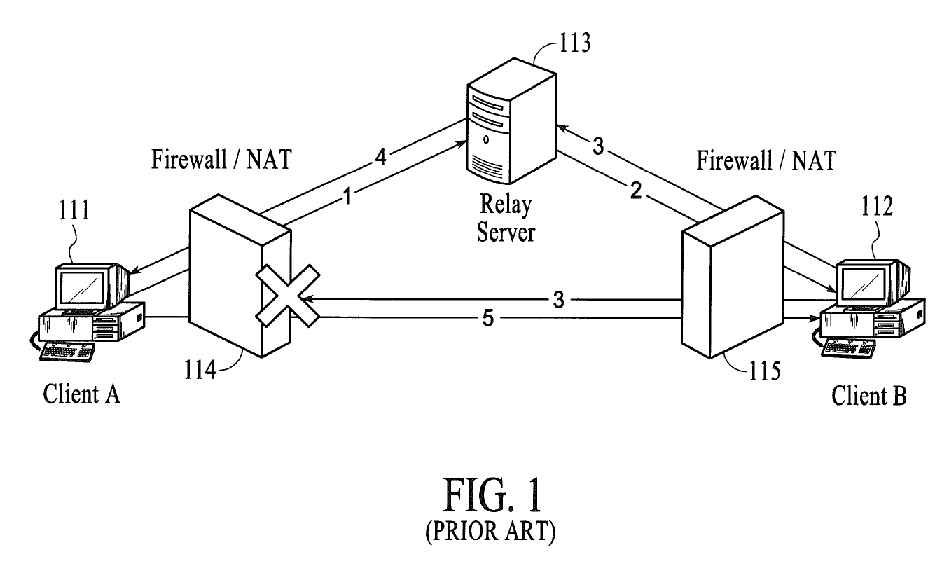

FIG. 2 is a block diagram of a network system that supports embodiments of a system for stateful handling of data packets.

FIG. 3 is a block diagram that illustrates server functionality for the network system of FIG. 2, under an embodiment.

FIG. 4 is a flow diagram illustrating a method of client assisted active FTP, under an embodiment.

FIG. 5 is a flowchart illustrating a method of client assisted stateful handling of packets in an active FTP application, under an embodiment.

FIG. 6 is a flowchart illustrating a method of client assisted stateful handling of packets in real time streaming protocol applications, under an embodiment.

### DETAILED DESCRIPTION

Systems and methods are described for providing client assisted stateful handling in a packet-based network. It should be appreciated that an embodiment can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein. In the context of this document, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

The disclosure of co-pending U.S. patent application Ser. No. 12/472,863, which is incorporated in full herein, includes discussion of an aggregated session management (“ASM”) system. A person having ordinary skill in the art will appreciate that the system that implements ASM as described in U.S. patent application Ser. No. 12/472,863 may also implement embodiments of this disclosure.

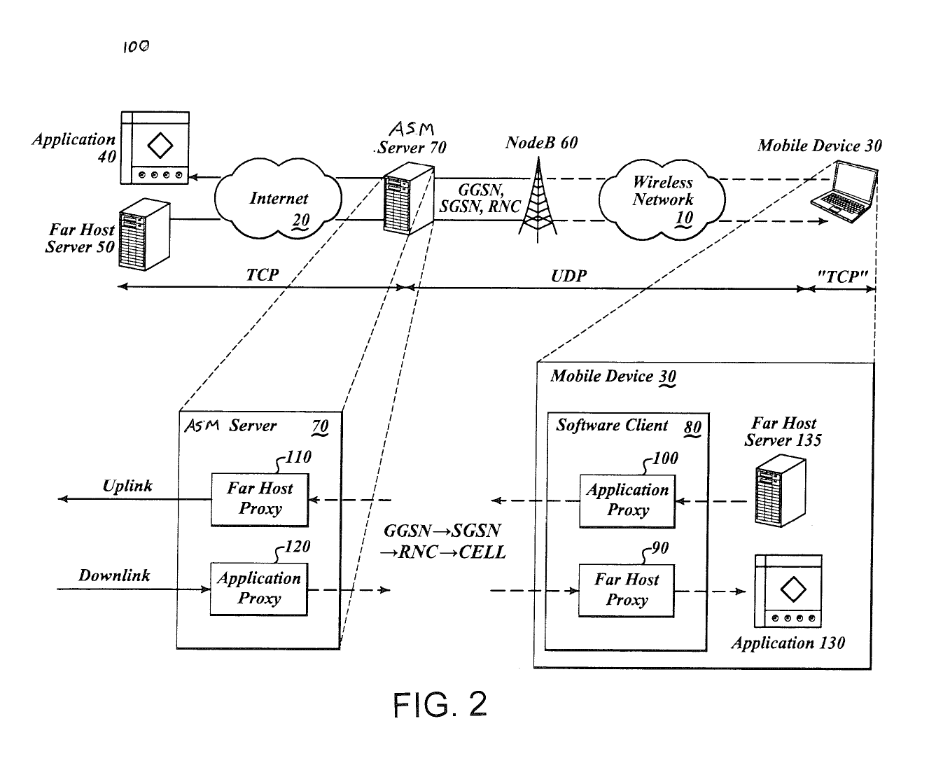

FIG. 2 is a block diagram of a network system that supports embodiments of a system for stateful handling of data packets. In the system 100, the ASM server 70 can be seen as a computer network gateway, similar in function to a NAT. In system 100, a proxy server 70 is located at the point of initial traffic entry from the Internet to the mobile network. As shown in FIG. 2, an embodiment of this disclosure may be implemented on a network, including wireless network 10 and a wired network, such as the Internet 20. The system embodiment of FIG. 2 may manage data flow between mobile communication device 30 and application 40 operating on far host server 50. Mobile communication device 30 may also be referred to herein as “client device 30” or “mobile device 30.”

As shown in FIG. 2, mobile device 30 may access application 40, first through wireless network 10 which may be linked to Node B 60, and then through Gateway General Serving Support Node (“GGSN”), Serving GPRS Support Node (“SGSN”), or Radio Network Controller (“RNC”) to ASM (or “Proxy”) Server 70, which in turn may access application 40 through the Internet 20. In an embodiment described further below, the protocol used for packets transmitted between ASM server 70 and mobile device 30 may be UDP, while TCP may be used for packets transmitted between ASM server 70 and far host server 50. One of ordinary skill in the art will appreciate that even though ASM server 70 is shown as a single server computer, proxy server 70 may in fact comprise one or more computers. The elements shown in FIG. 2 are not intended to limit this disclosure in any way.

In an embodiment, ASM server 70 may be located at the point of initial traffic entry from the Internet to the mobile network. In a UMTS or GSM based network, this may be at the Gi interface of GGSN. Mobile device 30 may include software client 80, which may include far host proxy 90 and application proxy 100. ASM Server 70 may include its own far host proxy 110 and application proxy 120. In an embodiment, application proxies 100 and 120 may each terminate the TCP flows, extract the payload and encapsulate the payload into a UDP packet. In an embodiment, far host proxies 90 and 110 may each receive the UDP packet, extract the payload and present the payload to the application as a TCP packet.

Application proxy 120 within proxy server 70 may terminate TCP flows from far-host server 50 within the Internet 20. Within software client 80 on mobile device 30, application proxy 100 may terminate TCP flows from the application 130 running on mobile device 30. Mobile device 30 may act as far host server 135 in messages sent to application 40.

In an embodiment, far host proxy 110 within ASM server 70 may reverse the effects of application proxy 120 by converting packets to TCP. Within software client 80, however, the TCP packet may not be created, but the payload may be presented to application 130 as though it came from a TCP socket of the operating system operating on mobile device 30.

ASM server 70 may use application proxy 120 for downstream data flow (i.e. to mobile device 30) and may use far host proxy 110 for upstream data flow (i.e. to far host server 50). Software client 80 on mobile device 30 may use application proxy 100 for upstream data flow and far host proxy 90 for downstream data flow. Combined, the four proxies, 90, 100, 110 and 120 are referred to herein as the Dynamic Multimedia Proxy (“DMP”). In this fashion, the DMP allows for flow control specifically designed for wireless networks, while “hiding” the behavior of the wireless network from the original TCP far host and TCP client flow control mechanisms.

Network system 100 of FIG. 2 can be used to support a system for facilitating client assisted stateful handling data communications within the network. For this implementation, ASM server 70, which is located at the point of initial traffic entry from the Internet to the mobile network, functions as an ASM server. In a UMTS or GSM based network, this server is located at the GI interface of GGSN. In addition, a software client module 80 is loaded onto the mobile device 30. Both of the components contain two proxy functions that act similarly, that is, as an application proxy and a far host proxy. The application proxy terminates the TCP flows, extracts the payload and encapsulates it into a UDP packet. The far host proxy receives the UDP packet, extracts the payload and presents it to the application as a TCP packet. The application proxy within the server terminates TCP flows from far-host servers sitting somewhere on the Internet. Within the mobile device client 30, the application proxy 120 terminates TCP flows from the applications that are running on the client itself. The far host proxy 110 within the server 70 essentially reverses the effects of the application proxy 120 by converting the packet to TCP. Within the software client 80 however, the TCP packet is not created but the payload is presented to the application as though it came from a TCP socket of the operating system.

The ASM server 70 acts as an application proxy for downstream data flow (i.e. towards the mobile client 30) and the far host proxy for upstream data flow. The software client 80 acts as the application proxy for upstream data flow and the far host proxy for downstream data flow. Combined, the four proxies make up the dynamic multimedia proxy (DMP).

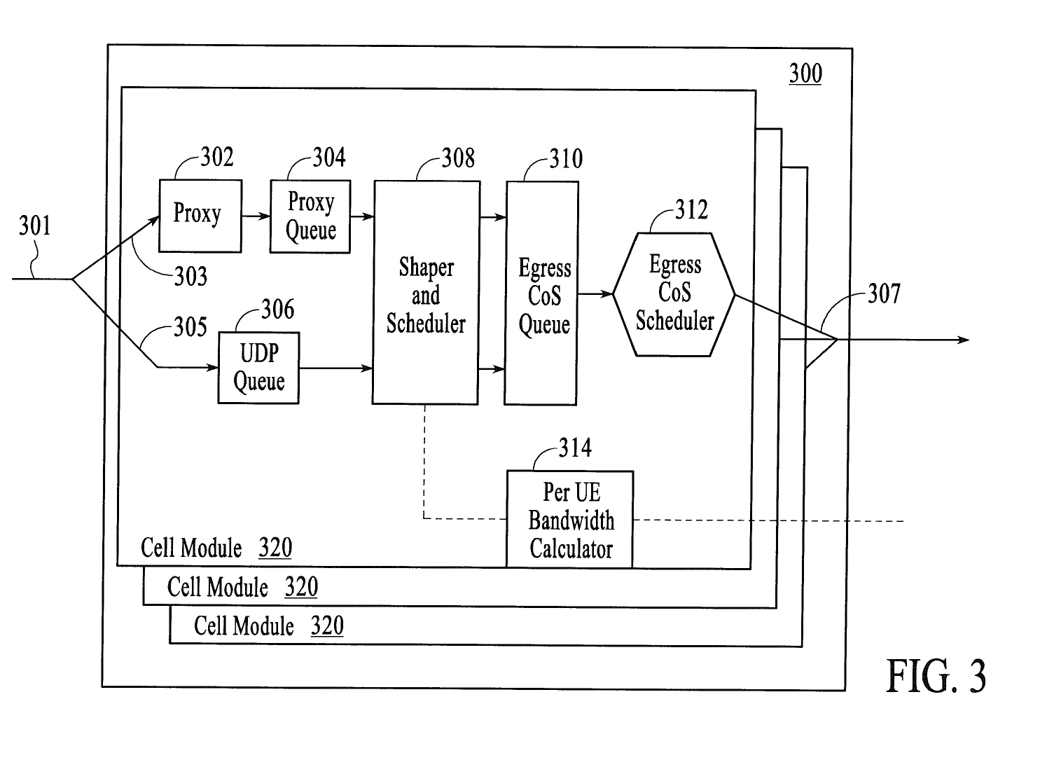

The server's application proxy has several additional components to ensure efficient data flow. A deployed network may have multiple cells or subnetworks. Each of the multiple cells is required to manage its own data flow. FIG. 3 is a block diagram that illustrates server functionality for the network system of FIG. 2 for a network with multiple cells, under an embodiment. As shown in FIG. 3, within the server 300, a plurality of separate cell modules 320 are present. Each cell 320 is assigned a unique module to monitor traffic passing through. As shown for the embodiment of FIG. 3, several functional components are implemented within each cell module 320. A first component is the proxy module 302. The proxy 302 appears to the far host for an application. It terminates the TCP protocol providing the host with all required handshakes. The proxy queue 304 holds all the payloads for a given TCP session and is required for each individual session. The output of the proxy queue 304 is the TCP payload encapsulated in a UDP packet. The UDP queue 306 holds all the UDP sessions. A shaper and scheduler module 308 schedules out the UDP payloads from both the proxy queue 304 and the UDP queue 306 and enqueues the packets into an egress CoS (class of service) queue 310. The shaper and scheduler 308 further ensures both appropriate fairness for all subscribers on a cell 320 and appropriate fairness for all sessions active on a client. For a typical network implementation, each cell 320 may have a set of such egress CoS queues. For example, for a UMTS implementation, there may typically be three cells per NodeB antenna. All traffic that is destined for this NodeB is placed in these queues. An egress CoS scheduler module 312 selects which egress CoS queue to extract the next to be transmitted from. The egress CoS scheduler 312 uses an algorithm based on typical QoS (Quality of Service) requirements. The final illustrated component is the per UE bandwidth calculator 314. This calculator considers both the bandwidth available on the wireless network and the bandwidth available to the UE and calculates the optimal bandwidth for transmission.

With regard to data flow, as shown in FIG. 3, an incoming data stream 301 is processed by different components within the cell 320. The upper stream 303 represent TCP that are handled by the TCP processing components of the cell, while the lower stream 305 are handled by the UDP processing components of the cell. The final output from the cell 320 is then output from the egress CoS scheduler 312 and may be combined with the output of the other cells to form the output of the server 300.

The system of FIG. 3 provides for optimum traffic flow speed based on incoming bandwidth information 309 provided to the bandwidth calculator 314. The calculated optimal bandwidth is provided to the scheduler and shaper 308, which performs two tasks. First, it schedules the delivery of packets into CoS queues by fairly selecting a UE and then fairly drawing a packet from one of that particular user's session queues. In addition to this scheduling, it shapes the flow of data. Based on the incoming bandwidth information provided by bandwidth calculator 314 on the aggregate of all streams terminating at the particular UE, the scheduler 308 determines the optimal flow speed of the user equipment.

### Client Assisted Application Level Gateway

In an embodiment, the stateful inspection of incoming protocols is offloaded from the server and distributed to the client device. The stateful inspection, as well as the provisioning of the client with the necessary functions required by the handlers, is referred to as Client Assisted Application Level Gateway (ALG). This variation on ALG, in which the client performs or assists the server by performing at least some of the inspection and provisioning tasks, allows for a marked performance gain to the network gateway by reducing its packet inspection load.

This model can also be extended to implement dynamically loadable plug-in applications by distributing the functionality between the software client and the ASM server. A plug-in implemented in such a split fashion can communicate between software client and the ASM server using the messaging facilities provided by DMP.

Embodiments are directed to active FTP transfers. Generally speaking, in active mode FTP, the client connects from a random unprivileged port (N>1023) to the FTP server's command port, port 21. The client then starts listening to port N+1 and sends the FTP command PORT N+1 to the FTP server, The server will then connect back to the client's specified data port from its local data port, which is port 20.

To perform active FTP transfers using client assisted techniques, the software client implements a stateful FTP plug-in program. Various configuration settings may need to be established depending upon the actual network implementation. For example, with TCP protocol, the default FTP control port is 21. Accordingly, for this type of network, the client plug-in handles all connections to any server using this TCP control port as the destination port.

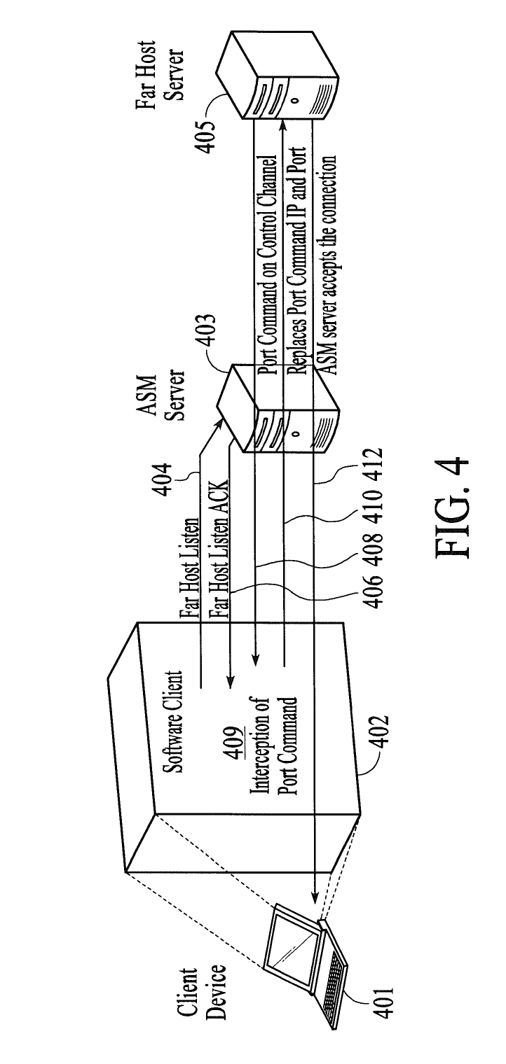

FIG. 4 is a flow diagram illustrating the components and processes of performing client assisted active FTP, under an embodiment. As shown in FIG. 4, the software client program 402 is installed and executed on a client device 401. Software client 402 keeps track of all outgoing flows to TCP the default FTP control port (e.g., port 21). The software client 402 begins handling the FTP control sessions statefully and keeps track of all listening sockets opened by FTP application. When the FTP application is running in active mode it will create a listening socket for data connection bound to a dynamically allocated port.

As shown in FIG. 4, the software client 402 relays the listen request to ASM server 403 as a “Far Host Listen” signal 404. This signal instructs the ASM server 403 to start a listening on a TCP socket the client's behalf. The ASM server 403 allocates a new listening session, and also binds that socket with an IP address and Port from its public IP/Port pool. The ASM server 403 sends a “Far Host Listen” acknowledge (ACK) signal 406 back to the software client 402. This acknowledgement signal 406 contains IP Address and TCP Port information for the listening socket.

The software client 402 stores the IP and port information inside the session control block and returns a listen success packet back to the application. The application executing on the far host server 405 issues a PORT command on the FTP control channel, link 408. The software client 402 intercepts the PORT command from the far host server 405 and gets the port number that is being communicated by the host server as shown in FIG. 4 as act 409. The software client 402 then matches the port number with the tracked listening sessions. The software client 402 next replaces the PORT command's IP Address and TCP Port with the IP Address and TCP Port from the listening socket, and forwards the message to the application on the far host server 405, link 410.

The FTP server 405 processes the PORT commands and opens up a connection to the IP Address and TCP Port. The ASM server 403 accepts the connection and associates it with the listening session control block, link 412. At this point, all data and signaling may be performed in the same way as a normal streamed flow in ASM.

The software client in FIG. 4 essentially operates by making the ASM server 403 aware that it is expecting an incoming connection from some external host server, such as far host server 405. The software client 402 adopts the role of the stateful handler and thus facilitates the reduction of the load on the ASM server 403, as well as a successful active FTP connection between the external server 405 and the client device 401.

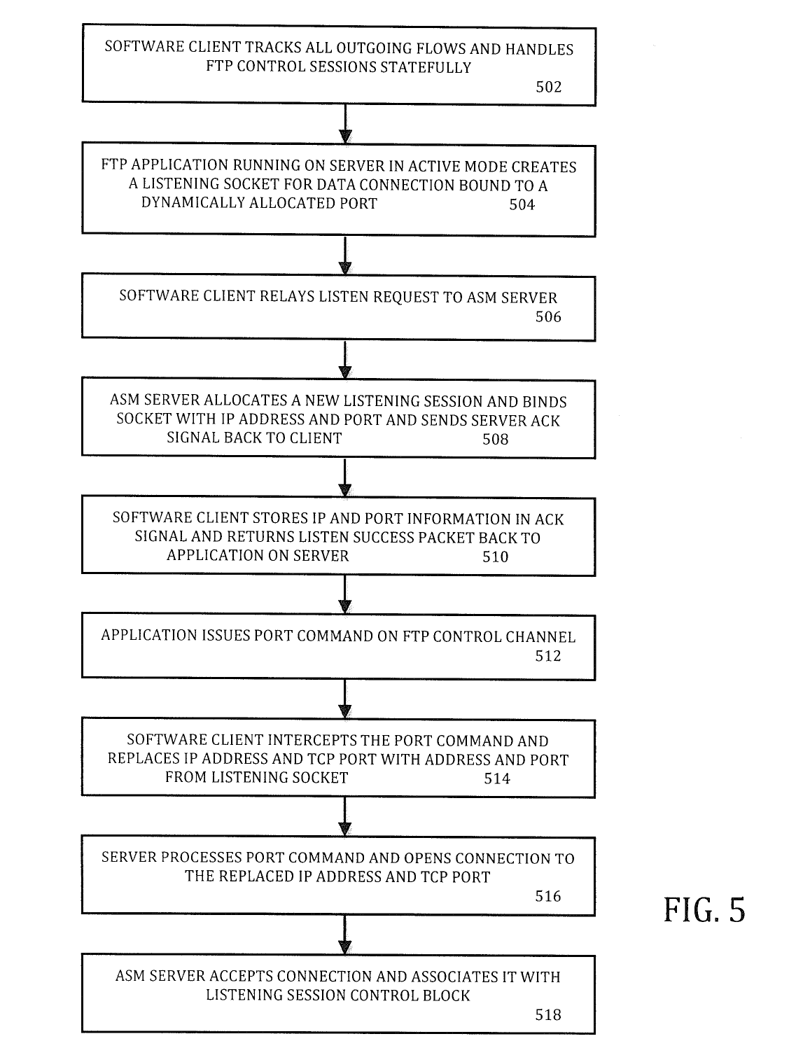

FIG. 5 is a flowchart illustrating a method of client assisted stateful handling of packets in an active FTP application, under an embodiment. The software client tracks all outgoing flows and handles the FTP control sessions in a stateful manner, and keeps track of all listening sockets opened by the FTP application that is running on a server coupled to the client device, block 502. The FTP application runs in active mode and creates a listening socket for a data connection bound to a dynamically allocated port, block 504. The software client relays the listen request to the ASM server as a host or server listen signal, block 506. This instructs the ASM server to start listening on a TCP socket on behalf of the client device. In response, the ASM server allocates a new listening session and binds the socket with an IP address and Port from its public pool, block 508. The software client stores the IP Address and port information inside the session control block and returns a listen success packet back to the application, block 510. The application issues a PORT command on the FTP control channel, block 512. The software client intercepts this PORT command and replaces the IP address and TCP port with the address and port from the listening socket, block 514. The software client then forwards the message to the application, and the server processes the PORT commands and opens up a connection to the IP address and TCP port that were replaced by the software client, block 516. The ASM server accepts the connection and associates it with the listening session control block, block 518. After this address/port interception and replacement process by the software client, all signaling and data transmission proceeds as normal for streamed flow in ASM.

Embodiments can also be used in real time streaming protocol (RTSP) applications. RTSP streaming applications, such as those supporting Real-Time Transport Protocol (RTP) and Real Data Transport (RDT) streaming over UDP, require the NAT gateway to map and forward the incoming UDP stream to the appropriate client. In order to do so, the RTSP client communicates the streaming ports that are open for receiving the stream to the server over the RTSP control channel. As RTSP streaming over UDP requires stateful handling of RTSP messages, the ASM server maps and forwards the UDP stream to appropriate UE where the software client performs the appropriate handling.

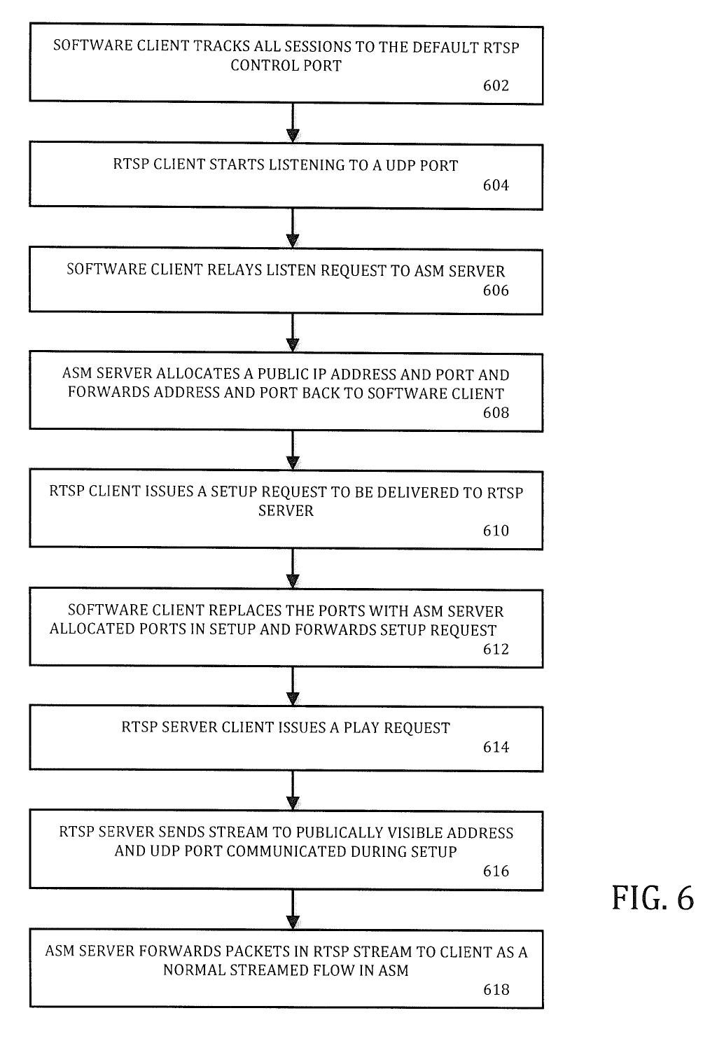

FIG. 6 is a flowchart illustrating a method of client assisted stateful handling of packets in real time streaming protocol applications, under an embodiment. As shown in FIG. 6, the process begins with the software client tracking all sessions to the default RTSP control port (e.g., port 554), block 602. When the RTSP client is performing RTSP streaming over UDP it starts listening to a UDP port, which is a port that is a dual port pair for RTP/RTSP, block 604. Next, the software client relays a “Listen” request to the ASM server, block 606. The ASM server allocates a Public IP/Port and forwards the IP address and port back to the software client, block 608. The RTSP client issues a SETUP request to be delivered to the RTSP Server to setup the stream using the original listening port, block 610. The software client then replaces the ports with the ASM Server allocated ports in the SETUP and then forwards the SETUP request, 612. The RTSP client issues a play request to receive the streamed content, block 614. In response, the RTSP server sends the stream to the publically visible IP address and UDP port that were communicated by the client during SETUP, block 616. As shown in block 618, the ASM server forwards the packets in the RTSP stream to the client in the same manner as a normal streamed flow in ASM.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Embodiments are directed to packet-based communication systems. A packet is generally understood to be a formatted unit of data carried by a packet mode computer network. A packet generally consists of two kinds of data: control information and user data, which is the payload. The control information provides information to help deliver the user data, such as source and destination addresses, error detection codes, and sequencing information. The control information is usually stored in packet headers and trailers that bracket the payload. Although embodiments are described with respect to IP packets, it should be understood that alternative embodiments can be directed to other types of packet-based communication systems.

Embodiments of the client assisted stateful handling system can be used in conjunction with a multimedia network architecture that uses wireless mobile client devices, such as smartphones that connect to the Internet through wireless operators and/or ISP entities. Such a network architecture may comprise a two-node system that includes the mobile client device and a gateway node to at the wireless carrier's data center. A client agent, that includes the software client module 402, turns the mobile client device into an intelligent network element. The client side modules in conjunction with the server side components enforce communication policies on both the uplink and downlink, prioritize applications and classes of service, and adapts the transport layer protocol to the available link to provide end-to-end solutions for improving mobile performance. Certain source-based policy controls embedded in the network enables carriers to control network access and limit the impact of unacceptable network use on service delivery. Processing components are configured to determine the policy applied to the traffic on the source and manage and control the traffic at its source. This helps to ensure that each application receives an optimum level of service and prevents bandwidth consumers from monopolizing the network. The network can also include protocol managers that improve communications quality by helping adapt bandwidth to the link's signal-to-noise ratio. Such a network may be embodied within the .Wave™ (dot Wave) multimedia services product set provided by Mobidia, Inc. of Vancouver, BC, Canada.

Embodiments are directed to a method and implementing system for providing stateful handling of packets in a communications network coupling an application server to a client, the method comprising: monitoring, on the client, all outgoing traffic flow to a default File Transfer Protocol (FTP) control port and monitoring a listening socket opened by an application executed on the application server, relaying a listen request created by the application to an aggregated service manager server coupled to the network; receiving, in the client, a server listen acknowledge signal from the aggregated service manager server, the acknowledge signal including an address and port number for the listening socket; intercepting, in the client, a port command issued by the application server in response to a listen success packet transmitted back to the application by the client; replacing, in the client, a network address and port number in the port command with an address and port number from the listening socket; and transmitting from the client to the application, a message with the replaced address and port number. The method further comprises storing, in a listening session control block in the client, the port and address number information contained in the application server listen acknowledgement signal generated by the aggregated service manager server. In this method, the aggregated service manager server allocates a new listening session in response to the listen request from the client, and wherein the aggregated service manager server binds the listening socket with an address and port number from a public pool of addresses and port numbers maintained by the aggregated service manager server. The method may further comprise the application server opening a connection to the replaced address and port number to send data transmissions related to the application. The method may yet further comprise associating, in the aggregated service manager server, the opened connection with the listening session control block.

In an embodiment of this method and system, the network comprises a TCP/IP (Transmission Control Protocol/Internet Protocol) network, and the outgoing traffic flow comprises packet based data transmission. The address and replaced address both comprise IP addresses, and wherein the port number and replaced port number both comprise FTP ports.

The client may be a wireless mobile device coupled to the network over at least one wireless link, in which case, the wireless link is maintained by a telephonic wireless communication carrier.

The aggregated services manager server may comprise a proxy server located at a point of initial traffic entry from the Internet to the wireless link, and the application server may comprise a far host server. In an embodiment, the aggregated services manager server executes a first application proxy program and a first far host server program to process data packets transmitted between the application server and the client, and the client executes a second application proxy program and a second far host server program to process the data packets transmitted between the application server and the client.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method for providing stateful handling of packets in a communications network coupling an application server to a client, the method comprising:
monitoring, on the client, all outgoing traffic flow to a default File Transfer Protocol (FTP) control port and monitoring a listening socket opened by an application executed on the application server;
relaying a listen request created by the application to an aggregated service manager server coupled to the network;
receiving, in the client, a server listen acknowledge signal from the aggregated service manager server, the acknowledge signal including an address and port number for the listening socket;
intercepting, in the client, a port command issued by the application server in response to a listen success packet transmitted back to the application by the client;
replacing, in the client, a network address and port number in the port command with an address and port number from the listening socket; and
transmitting from the client to the application, a message with the replaced address and port number.

2. The method of claim 1 further comprising storing, in a listening session control block in the client, the port and address number information contained in the application server listen acknowledgement signal generated by the aggregated service manager server.

3. The method of claim 2 wherein the aggregated service manager server allocates a new listening session in response to the listen request from the client, and wherein the aggregated service manager server binds the listening socket with an address and port number from a public pool of addresses and port numbers maintained by the aggregated service manager server.

4. The method of claim 3 further comprising opening, on the application server, a connection to the replaced address and port number.

5. The method of claim 4 further comprising associating, in the aggregated service manager server, the opened connection with the listening session control block.

6. The method of claim 1 wherein the network comprises a TCP/IP (Transmission Control Protocol/Internet Protocol) network, and wherein the outgoing traffic flow comprises packet based data transmission.

7. The method of claim 6 wherein the address and replaced address both comprise IP addresses, and wherein the port number and replaced port number both comprise FTP ports.

8. The method of claim 7 wherein the client is a wireless mobile device coupled to the network over at least one wireless link, the wireless link maintained by a telephonic wireless communication carrier.

9. The method of claim 8 wherein the aggregated services manager server comprises a proxy server located at a point of initial traffic entry from the Internet to the wireless link.

10. The method of claim 9 wherein the application server comprises a far host server, and wherein the aggregated services manager server executes a first application proxy program and a first far host server program to process data packets transmitted between the application server and the client.

11. The method of claim 10 wherein the client executes a second application proxy program and a second far host server program to process the data packets transmitted between the application server and the client.

12. A system for providing stateful handling of packets in a communications network, comprising:
an aggregated services manager server coupled to the network and executing a first application proxy program and a first far host server program to process data packets transmitted over the network; and
a network client, the method comprising executing a second application proxy program and a second far host server program to process data packets transmitted to and from an application over the network, the network client configured to
monitor all outgoing traffic flow to a default control port,
monitor a listening socket opened by the application,
relay a listen request created by the application to the aggregated service manager,
receive a server listen acknowledge signal from the aggregated service manager server, wherein the acknowledge signal includes an address and port number for the listening socket,
intercept a port command issued by the application server in response to a listen success packet transmitted back to the application by the client,
replace a network address and port number in the port command with an address and port number from the listening socket, and
transmit to the application, a message with the replaced address and port number.

13. The system of claim 12 wherein the aggregated service manager server is configured to:
allocate a new listening session in response to the listen request from the client;
bind the listening socket with an address and port number from a public pool of addresses and port numbers maintained by the aggregated service manager server; and
associate the opened connection with the listening session control block.

14. The system of claim 13 wherein the application server is configured to open a connection to the replaced address and port number.

15. The system of system of claim 12 wherein the network comprises a TCP/IP (Transmission Control Protocol/Internet Protocol) network, and wherein the outgoing traffic flow comprises packet based data transmission, and further wherein the address and replaced address both comprise IP addresses, and wherein the port number and replaced port number both comprise FTP ports.

16. The system of claim 15 wherein the client is a wireless mobile device coupled to the network over at least one wireless link, the wireless link maintained by a telephonic wireless communication carrier, and wherein the aggregated services manager server comprises a proxy server located at a point of initial traffic entry from the Internet to the wireless link.

17. A machine-readable medium containing one or more sequences of instructions for providing client assisted stateful handling of packets in a communications network coupling a client computer to an application server computer, the instructions configured to cause a processor in the client computer to:
monitor all outgoing traffic flow to a default File Transfer Protocol (FTP) control port and monitoring a listening socket opened by an application executed on the application server,
relay a listen request created by the application to an aggregated service manager server coupled to the network;
receive a server listen acknowledge signal from the aggregated service manager server, the acknowledge signal including an address and port number for the listening socket;
intercept a port command issued by the application server in response to a listen success packet transmitted back to the application by the client;
replace a network address and port number in the port command with an address and port number from the listening socket; and
transmit to the application, a message with the replaced address and port number.

18. The medium of claim 17 further comprising instructions configured to cause the processor to store, in a listening session control block in the client, the port and address number information contained in the application server listen acknowledgement signal generated by the aggregated service manager server.

19. The medium of claim 17 further comprising instructions configured to cause the processor to allocate in the aggregated service manager server, a new listening session in response to the listen request from the client, and wherein the aggregated service manager server binds the listening socket with an address and port number from a public pool of addresses and port numbers maintained by the aggregated service manager server.
